(19) United States
(12) Patent Application Publication
(10) Pub. No.: US 2025/0282236 A1
(43) Pub. Date: Sep. 11, 2025

(54) CONTACTLESS CHARGING SYSTEM

(71) Applicant: Toyota Jidosha Kabushiki Kaisha, Toyota-shi (JP)

(72) Inventor: Hirotaka SAITO, Sunto-gun (JP)

(73) Assignee: Toyota Jidosha Kabushiki Kaisha, Toyota-shi (JP)

(21) Appl. No.: 19/061,225

(22) Filed: Feb. 24, 2025

(30) Foreign Application Priority Data
Mar. 8, 2024 (JP) 2024-036288

(51) Int. Cl. B60L 53/126; H02J 50/90

(52) U.S. Cl. CPC B60L 53/126; H02J 50/90

(57) ABSTRACT

A contactless charging system receives power transmitted from a power transmitting coil of a power supply facility provided outside of a vehicle in a contactless manner by a power receiving coil of a power receiving unit provided in the vehicle, and charges a power storage device mounted on the vehicle. The contactless charging system includes a control device configured to determine, in a case where position judgement of whether a relative position between the power transmitting coil and the power receiving coil is a position capable of charging is not completed at a time of READY-OFF, whether or not the vehicle is stopped and the relative position is the position capable of charging after a predetermined time has elapsed from the time of READY-OFF, and perform charging in a case where it is judged that the vehicle is stopped and the relative position is the position capable of charging.

The present application claims priority to and incorporates by reference the entire contents of Japanese Patent Application No. 2024-036288 filed in Japan on Mar. 8, 2024.

### BACKGROUND

The present disclosure relates to a contactless charging system.

JP 2017-121177 discloses a contactless charging apparatus for reducing the power supply power from the power supply coil as the distance away by detecting the relative position between the power receiving coil on the ground side and the vehicle side after the start of charging.

### SUMMARY

In the contactless charging device disclosed in JP 2017-121177, the position judgement of whether the relative position between the power supply coil and the power receiving coil may be charged at the time of READ-OFF of the vehicle is not completed, there is a possibility that the charging is not executed.

There is a need for a contactless charging system capable of performing charging even when the position judgement of the power transmitting coil and the power receiving coil has not been completed at the time of READY-OFF of the vehicle.

According to one aspect of the present disclosure, there is provided a contactless charging system for receiving power transmitted from a power transmitting coil of a power supply facility provided outside of a vehicle in a contactless manner by a power receiving coil of a power receiving unit provided in the vehicle, and charging a power storage device mounted on the vehicle, the contactless charging system including a control device configured to determine, in a case where position judgement of whether a relative position between the power transmitting coil and the power receiving coil is a position capable of charging is not completed at a time of READY-OFF of the vehicle, whether or not the vehicle is stopped and the relative position is the position capable of charging after a predetermined time has elapsed from the time of READY-OFF, and perform charging in a case where it is judged that the vehicle is stopped and the relative position is the position capable of charging after the predetermined time has elapsed from the time of READY-OFF.

### BRIEF DESCRIPTION OF THE DRAWINGS

FIG. 1 is a diagram schematically illustrating a contactless charging system according to an embodiment;

FIG. 2 is a diagram illustrating a parking space in which the contactless charging system is provided according to the embodiment;

FIG. 3 is a block diagram illustrating a schematic configuration of a contactless charging system according to the embodiment;

FIG. 4 is a timing chart illustrating an example of a contactless charging control in the contactless charging system according to the embodiment; and

FIG. 5 is a flowchart illustrating an example of the contactless charging control in the contactless charging system according to the embodiment.

### DETAILED DESCRIPTION

Hereinafter, an embodiment of a contactless charging system according to the present disclosure is explained. Note that the present disclosure is not limited by the embodiment.

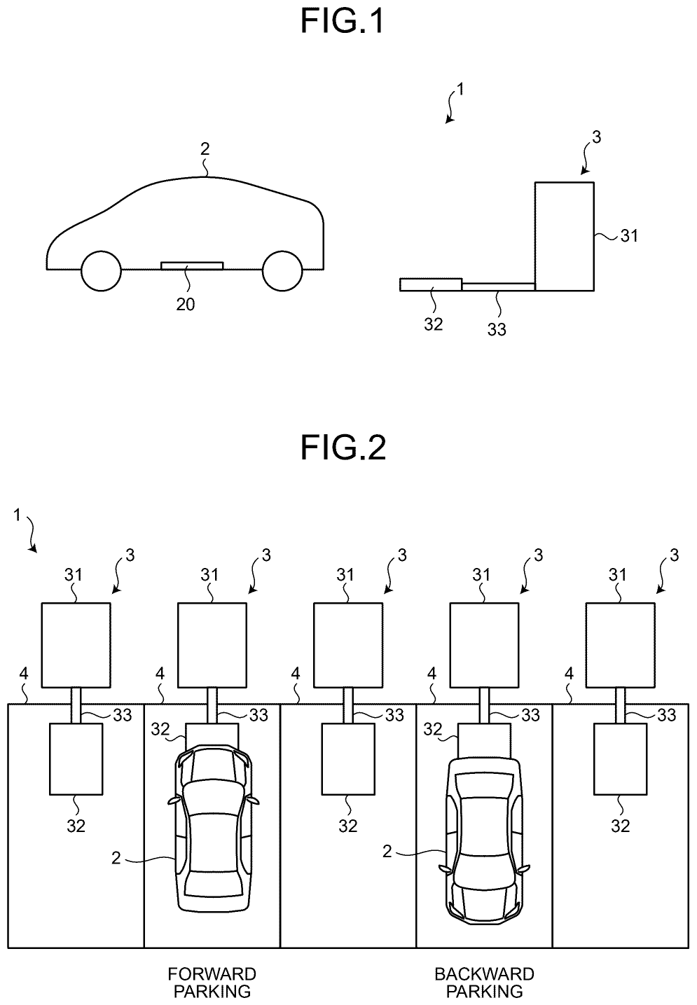

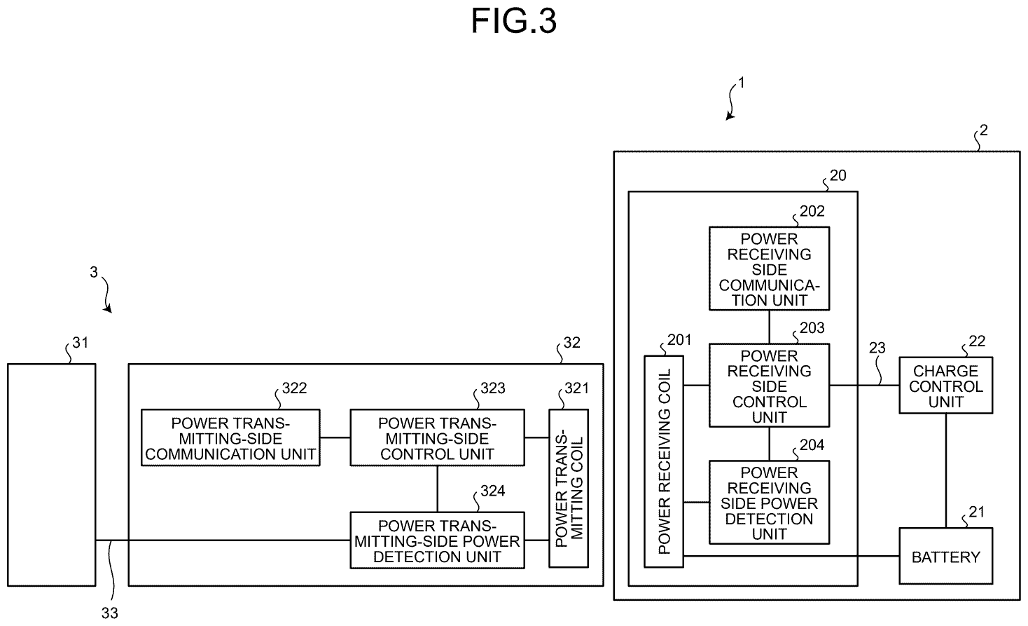

FIG. 1 is a diagram schematically illustrating a contactless charging system 1 according to the embodiment. FIG. 2 is a diagram illustrating a parking space 4 in which the contactless charging system 1 according to the embodiment is provided. FIG. 3 is a block diagram illustrating a schematic configuration of the contactless charging system 1 according to the embodiment.

The contactless charging system 1 according to the embodiment is constituted by a vehicle 2 and the power supply facility 3 provided outside the vehicle.

The contactless charging system 1 according to the embodiment includes a power transmitting unit 32 of the power supply facility 3 provided on the ground, and a power receiving unit 20 provided in the vehicle 2. The contactless charging system 1 is a system for charging the power transmitted from the power transmitting unit 32 to the power receiving unit 20 to the battery 21 that is a power storage device for driving the vehicle 2 in a contactless manner in a state in which the vehicle 2 is parked in the parking space 4 in which the power transmitting unit 32 is installed. The vehicle 2 is an electric vehicle equipped with a traveling motor, and includes the power receiving unit 20, the battery 21, and a charge control unit 22. The vehicle 2 is an electric vehicle capable of external charging by contactless power supply.

The power supply facility 3 includes a power supply device 31, the power transmitting unit 32, and a power cable 33. The power supply device 31 and the power transmitting unit 32 are connected by the power cable 33. The power supply device 31 outputs, for example, a commercial AC power supplied from the system power source to the power transmitting unit 32 via the power cable 33. The power transmission unit 32 is provided in the parking space 4 on the ground.

The power transmitting unit 32 includes a power transmitting coil 321, a power transmitting-side communication unit 322, a power transmitting-side control unit 323, and a power transmitting-side power detection unit 324. The power transmitting coil 321 is a coil for contactless power transmission provided on the ground. The power transmitting coil 321 performs power transmission in a contactless manner to the power receiving coil 201 mounted on the vehicle 2. Power is supplied to the power transmitting coil 321 through the power cable 33 or the like from the power supply device 31 connected to the power system.

The power transmitting-side communication unit 322 is a radio communication device for performing data communication with the power receiving unit 20. The power transmitting-side communication unit 322 performs wireless communication with the power receiving-side communication unit 202 mounted on the vehicle 2. The power transmitting-side communication unit 322 and the power receiving-side communication unit 202 transmit and receive information by wireless communication so that the power transmitting unit 32 on the ground side and the power receiving unit 20 on the vehicle 2 side perform data communication.

The power transmitting-side control unit 323 controls the power transmission in a contactless manner from the power transmitting coil 321 on the ground side to the power receiving coil 201 on the vehicle 2 side. The power transmitting-side control unit 323 controls the start of the contactless charging and the end of the contactless charging in response to a command signal from the power receiving unit 20. The command signal is received by the power transmitting-side communication unit 322. The power transmitting-side control unit 323 controls the power transmitting coil 321 based on the command signal received by the power transmitting-side communication unit 322.

The power transmitting-side power detecting unit 324 detects the power transmitted by the power transmitting coil 321 in a contactless manner. The power transmitting-side power detection unit 324 detects the power transmitted during the time from the start to the end of the contactless charging (transmitted power).

In the contactless charging system 1 according to the embodiment, the longitudinal direction of the positional deviation between the center position of the power receiving unit 20 of the vehicle 2 side (the power receiving coil 201) and the ground-side power transmitting unit 32 (power transmitting coil 321), and, lateral positional deviation may be detected. For example, the charging control unit 22 of the vehicle 2 detects, as the longitudinal direction of the positional deviation, the positional deviation of the center position of the power receiving unit 20 (power receiving coil 201) of the vehicle 2 side with respect to the center position of the ground-side power transmitting unit 32 (power transmitting coil 321). The charge control unit 22 acquires the longitudinal direction of the positional deviation amount (relative distance) between the power transmitting unit 32 (power transmitting coil 321) and the power receiving unit 20 (power receiving coil 201), and the lateral direction of the positional deviation amount (relative distance). The information of the positional deviation amount (relative distance) is positional information representing the relative positional relationship between the center position of the power receiving unit 20 (power receiving coil 201) and the center position of the power transmitting unit 32 (power transmitting coil 321).

As the position detection method, for example, there is a method of calculating using an imaging device such as a radar range finder or a camera. For example, there is a method in which a plurality of LED mounted on the power receiving unit 20 on the vehicle 2 side are photographed by cameras mounted on the power transmitting unit 32 on the ground side, and the distance between the center position of the power transmitting unit 32 and the center position of the power receiving unit 20 is calculated. As the position detecting method, for example, there is a method in which a plurality of LED mounted on the power transmitting unit 32 on the ground side are photographed by a camera mounted on the power receiving unit 20 on the vehicle 2 side, and the distance between the center position of the power transmitting unit 32 and the center position of the power receiving unit 20 is calculated. Further, as the position detection method, a defined weak power not affecting the human body from the power transmitting coil 321 of the power transmitting unit 32 on the ground side is transmitted to the power receiving coil 201 of the power receiving unit 20 of the vehicle 2 side, the value of the power received by the power receiving coil 201, the center position of the power transmitting coil 321 and the center position of the power receiving coil 201 which is set in advance calculated from the correspondence between the amount of positional deviation (relative distance).

The power receiving unit 20 is a vehicle-mounted contactless charging unit provided with a power receiving coil 201 for receiving power. The power receiving unit 20 is provided in the lower portion of the vehicle 2. The power receiving unit 20 includes a power receiving coil 201, a power receiving-side communication unit 202, a power receiving-side control unit 203, and a power receiving-side power detection unit 204.

The power receiving coil 201 is a coil mounted on the vehicle 2 for contactless power receiving and is provided in the lower portion of the vehicle 2. The power receiving coil 201 receives the power transmitted in a contactless manner from the power transmitting coil 321. In the vehicle 2, the power received by the power receiving coil 201 is supplied to the battery 21 to charge the battery 21.

The power receiving-side communication unit 202 is a radio for performing data communication with the power transmitting unit 32. The power reception side communication unit 202 performs wireless communication with the power transmitting-side communication unit 322 provided in the power transmitting unit 32.

The power reception side control unit 203 executes control to receive power transmitted from the power transmitting coil 321 on the ground side in a contactless manner by the power receiving coil 201 on the vehicle 2 side. The power receiving-side control unit 203 controls the start of the contactless charging and the end of the contactless charging. The power reception side control unit 203 executes the communication control to transmit a command signal for controlling the start and terminate of the contactless charging from the power receiving-side communication unit 202 to the power transmitting-side communication unit 322, and controls the power receiving coil 201.

In the contactless charging system 1, the control unit including the power transmitting-side control unit 323 and the power receiving-side control unit 203 is configured to control the power transmitting between the power transmitting unit 32 on the ground side and the power receiving unit 20 on the vehicle 2 side.

The power receiving-side power detecting unit 204 detects the power received by the power receiving coil 201 in a contactless manner. The receiving-side power detection unit 204 detects the time from the start to the end of the contactless charging, that is, the power received during charging (received power).

The battery 21 supplies power to the driving motor mounted on the vehicle 2. The battery 21 is constituted by a secondary battery capable of storing power for supplying to the traveling motor.

The charging control unit 22 executes the charging control for charging the power receiving coil 201 receives power to the battery 21. Further, the charge control unit 22 functions as a control device for determining the start and terminate of the contactless charging.

Further, the charge control unit 22 calculates the transmission efficiency at the time of contactless charging. The charging control unit 22 is configured to include a transmission efficiency calculating unit for calculating the transmission efficiency. The transmission efficiency is the ratio of the received power of the power receiving coil 201 to the transmitted power of the power transmitting coil 321. Both of the electric powers are actually measured during contactless charging. The transmitted power is an actual measured value detected by the power transmitting-side power detecting unit 324 during charging. The received power is an actual measured value detected by the power receiving-side power detecting unit 204 during charging.

The information of the transmitted power detected by the power transmitting-side power detection unit 324 is input from the power transmitting-side power detection unit 324 to the power transmitting-side control unit 323, and transmitted from the power transmitting-side communication unit 322 to the power receiving-side communication unit 202 of the vehicle 2 side. By the power receiving-side communication unit 202 receives the signal from the power transmitting-side communication unit 322, the charge control unit 22 may acquire information of the transmitted power.

The information of the received power detected by the power receiving-side power detection unit 204 is input from the power receiving-side power detection unit 204 to the power receiving-side control unit 203, and is transmitted from the power receiving-side control unit 203 to the charging control unit 22. The power receiving-side control unit 203 and the charge control unit 22 are communicatively connected via MAY communication line 23. The power reception side control unit 203 transmits the information of the transmitted power received by the power reception side communication unit 202 to the charging control unit 22. The charging control unit 22 acquires information of the received power and information of the transmitted power by receiving a signal from the power reception side control unit 203.

Then, the charging control unit 22 stores the transmission efficiency calculated by the transmission efficiency calculation unit in the transmission efficiency database. At that time, the charging control unit 22 stores the transmission efficiency calculated at the time of charging, and the position deviation amount detected at the time of charging as a set in the transmission efficiency database. The transmission efficiency database is a storage unit that stores the measured power transmitting efficiency (=transmission efficiency). Since the transmission efficiency depends on the charge rate (SOC) of the battery 21, a database is created for each SOC when the transmission efficiency is stored in the transmission efficiency database.

In the contactless charging system 1 configured in this way, the position where the transmission efficiency maximum estimated based on the power transmitting efficiency of the vehicle front-rear direction and the lateral direction which has been actually measured in advance (transmission efficiency maximum position) and the target parking position. The charge control unit 22 sets the position where the transmission efficiency is highest among the transmission efficiency database 50, or the position where the transmission efficiency obtained by the interpolation process is highest to the transmission efficiency maximum position. The charge control unit 22 sets the transmission efficiency maximum position set to the target parking position. That is, when the vehicle 2 is parked in the parking space 4 provided with the power supply facility 3, the transmission efficiency from the power transmitting efficiency data which has been measured in advance calculates the parking position becomes maximum, the calculated position and the target parking position. This makes it possible to maximize the charging efficiency.

Here, in the contactless charging system 1 according to the embodiment, the charging control unit 22 of the vehicle 2 determines whether or not the relative position between the power transmitting coil 321 on the ground side and the power receiving coil 201 on the vehicle 2 side is a position in which charging may be performed and then executes (starts) the charging. For example, the charge control unit 22 of the vehicle 2 determines that the position judgement is OK when the positional deviation amount (relative distance) between the center position of the power receiving unit 20 of the vehicle 2 side (power receiving coil 201) and the center position of the ground-side power transmitting unit 32 (power transmitting coil 321) as the positional information becomes equal to or less than a predetermined threshold. Further, in the position judgement, it is necessary that two conditions of “the vehicle 2 is stopped” and “the position information may be monitored (the position information is valid state)” are satisfied. On the other hand, there may be a case where the position judgement cannot be performed because the parking operation is too fast or the activation the position detection function is delayed. In this case, charging may not be started even though the vehicle is parked in an area where the user may charge.

For example, as illustrated in FIG. 2, in general, when parking the vehicle 2 in forward parking to approach in the parking space 4, parking operation may be faster than when parking the vehicle 2 in backward parking to approach in the parking space 4. Further, when a driver with a higher driving skill parks the vehicle 2 in the parking space 4, the parking operation may be faster than when a driver with lower driving skill parks the vehicle 2 in the parking space 4.

Therefore, in the contactless charging system 1 according to the embodiment, at the time of READY-OFF of the vehicle 2 parked in the parking space 4 in which the power transmitting unit 32 is installed, if the position judgement of the position where the relative position may be charged has not been completed, the charge control unit 22 of the vehicle 2 determines again whether to execute (start) the charging after a predetermined time has elapsed from the time of READY-OFF. Thus, in the contactless charging system 1 according to the embodiment, it is possible to execute (start) the charging even if the position judgement cannot be performed because the parking operation is too fast or the activation the position detection function is delayed.

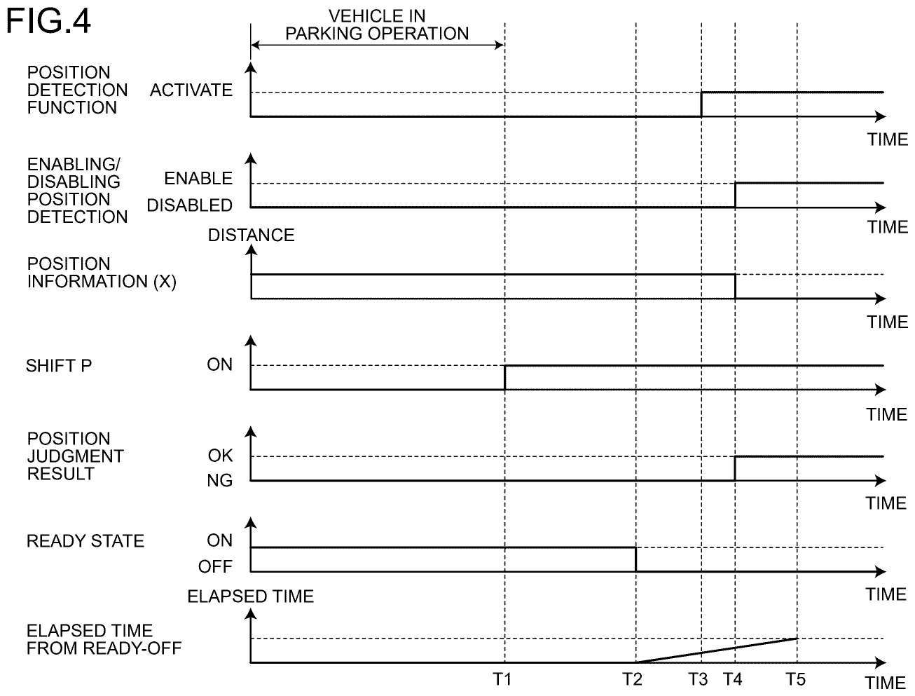

FIG. 4 is a timing chart illustrating an example of the contactless charging control in the contactless charging system 1 according to the embodiment.

In the embodiment illustrated in FIG. 4, the parking operation of the vehicle 2 with respect to the parking space 4 in which the power transmitting unit 32 is installed is started, the shift position of the vehicle 2 in the time T1 becomes P position, the vehicle 2 is stopped. In the contactless charging system 1 according to the embodiment, when the shift position of the vehicle 2 becomes the P position, it is detected that the vehicle 2 is stopped. Next, the time has elapsed from the time T1 to the time T2, and the vehicle 2 is in READY-OFF state. Next, at the time T3 when certain time elapsed from the time T2 after the vehicle 2 is turned READY-OFF, the position detection function of the charging control unit 22 is activated. The position detection function detects whether the relative position may be charged between the power transmitting unit 32 (power transmitting coil 321) and the power receiving unit 20 (power receiving coil 201). Incidentally, the power supply from the auxiliary battery mounted on the vehicle 2 to the charge control unit 22 is continued for a predetermined time (e.g., 30 seconds) even after the vehicle 2 is turned READY-OFF, and therefore, the charge control unit 22 may operate various controls. Next, the state detection is enabled at the time T4 after the time has elapsed since the time T3, and the position information is acquired. Between the time T3 and the time T4, although the position detection function is activated, since the initial-check and the state in which the position information is not yet output, the position information remains in the disabled state. As the position information (X), a constant value set in advance is acquired in the disabled state, and the distance corresponding to the position of the power receiving unit 20 of the vehicle 2 with respect to the ground-side power transmitting unit 32 is acquired as the position information when the position detection is in the enabled state. With regard to the position information (X), a value of the vertical axis representing the relative distance (positional deviation amount) between the power transmitting unit 32 and the power receiving unit 20 becomes smaller as the power receiving unit 20 of the vehicle 2 moves closer to the power transmitting unit 32 on the ground side. Then, the position judgement becomes “OK” when the position information (X) is equal to or less than the threshold which is a preset rechargeable relative distance (positional deviation amount). Then, the time T5 elapses time from the time T4, in other words, at the time T5 after a predetermined time has elapsed from the time T2 at the time of READY-OFF (for example, after 20 seconds), the vehicle 2 is stopped and the position judgement is OK to execute (start) the charging.

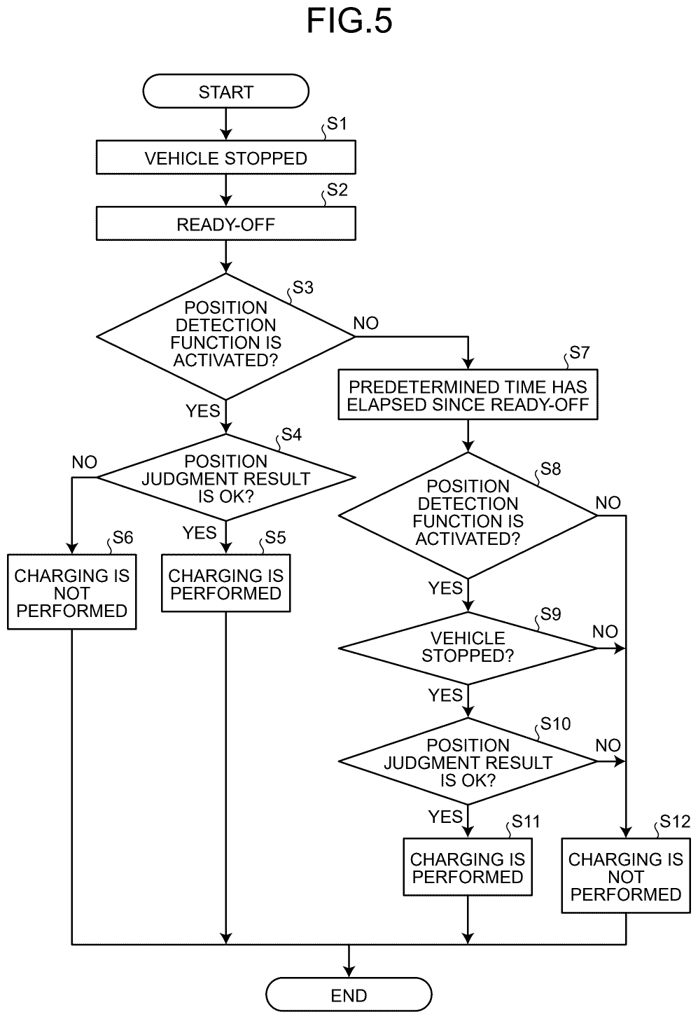

FIG. 5 is a flowchart illustrating an example of a contactless charging control in the contactless charging system 1 according to the embodiment.

First, the charge control unit 22 of the vehicle 2 detects that the shift position of the vehicle 2 becomes P position and the vehicle 2 is stopped (Step S1). Next, the charge control unit 22 detects READY-OFF of the vehicle 2 (Step S2). Next, the charge control unit 22 determines whether the position detection function is activated (Step S3). When it is determined that the position detection function is activated (Yes at Step S3), the charge control unit 22 determines whether the position judgement result is OK (Step S4). If the position judgement result is determined to be OK (Yes at Step S4), the charge control unit 22 performs the charging (Step S5). Thereafter, the charge control unit 22 ends the series of control. On the other hand, when it is determined that the position judgement result is not OK (the position judgement result is NG) (No at Step S4), the charge control unit 22 does not perform charging (Step S6). Thereafter, the charge control unit 22 ends the series of control.

Further, in the process of the step S3, when it is determined that the position detection function is not activated (No at Step S3), after a predetermined time has elapsed from READY-OFF (Step S7), the charge control unit 22 determines whether the position detection function is activated (Step S8). If it is determined that the position detection function is not activated (No at Step S8), the charge control unit 22 does not perform charging (Step S12). Thereafter, the charge control unit 22 ends the series of control. On the other hand, when it is determined that the position detection function is activated (Yes at Step S8), the charge control unit 22 determines whether the vehicle 2 is stopped (Step S9). If it is determined that the vehicle 2 is not stopped (No at Step S9), the charge control unit 22 does not perform charging (Step S12). Thereafter, the charge control unit 22 ends the series of control. On the other hand, when it is determined that the vehicle 2 is stopped (Yes at Step S9), the charge control unit 22 determines whether the position judgement result is OK (Step S10). If the position judgement result is determined to be OK (Yes at Step S10), the charge control unit 22 performs the charging (Step S11). Thereafter, the charge control unit 22 ends the series of control. On the other hand, when it is determined that the position judgement result is not OK (the position judgement result is NG) (No at Step S10), the charge control unit 22 does not perform charging (Step S12). Thereafter, the charge control unit 22 ends the series of control.

The contactless charging system 1 according to the embodiment, even when the position judgement cannot be performed at READY-OFF time, it is possible to perform (start) charging if the predetermined condition is satisfied.

In the contactless charging device according to the present disclosure, it is possible to perform charging even when the position judgement of the power transmitting coil and the power receiving coil has not been completed at the time of READY-OFF of the vehicle.

Moreover, even if the position detection function is activated after READY-OFF, it is possible to execute the charging as the position judgement is OK at the time the position information is below a preset threshold by satisfying the two conditions that the vehicle is stopped and the position information is valid state.

Moreover, the control device may make the position judgment result OK when the positional deviation becomes less than or equal to the chargeable thresholds.

It is possible to perform the control of executing the charging by the control device provided in the vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A contactless charging system for receiving power transmitted from a power transmitting coil of a power supply facility provided outside of a vehicle in a contactless manner by a power receiving coil of a power receiving unit provided in the vehicle, and charging a power storage device mounted on the vehicle, the contactless charging system comprising
a control device configured to
determine, in a case where position judgement of whether a relative position between the power transmitting coil and the power receiving coil is a position capable of charging is not completed at a time of READY-OFF of the vehicle, whether or not the vehicle has stopped and the relative position is the position capable of charging after a predetermined time has elapsed from the time of READY-OFF, and
perform charging in a case where it is judged that the vehicle has stopped and the relative position is the position capable of charging after the predetermined time has elapsed from the time of READY-OFF.

2. The contactless charging system according to claim 1, wherein the control device is configured to perform charging in a case where, after the time of READY-OFF: a position detecting function detecting whether or not the relative position is the position capable of charging is activated; position information detected by the position detecting function is a valid state; the vehicle has stopped; and the position information is equal to or less than a predetermined threshold.

3. The contactless charging system according to claim 2, wherein the position information is a position deviation amount of a center position of the power receiving coil and a center position of the power transmitting coil.

4. The contactless charging system according to claim 1, wherein the control device is provided in the vehicle.
